(19) United States
(12) Patent Application Publication
(10) Pub. No.: US 2021/0031166 A1
(43) Pub. Date: Feb. 4, 2021

(54) Solid Phase Microextraction Membranes Impregnated with Gold Nanoparticles: Creation of Novel SERS-Enhancing Substrates

(71) Applicants: Marc David Porter, Park City, UT (US); Jennifer Harnisch Granger, Salt Lake City, UT (US); Anton Sergeyevich Klimenko, Salt Lake City, UT (US)

(72) Inventors: Marc David Porter, Park City, UT (US); Jennifer Harnisch Granger, Salt Lake City, UT (US); Anton Sergeyevich Klimenko, Salt Lake City, UT (US)

(73) Assignee: University of Utah, Salt Lake City, UT (US)

(21) Appl. No.: 16/942,274

(22) Filed: Jul. 29, 2020

Related U.S. Application Data
(60) Provisional application No. 62/879,792, filed on Jul. 29, 2019.

(51) Int. Cl. B01J 20/02; B01J 20/32

(52) U.S. Cl. CPC B01J 20/0233; B01J 20/3236; B01J 2220/445; B01J 2220/46; B01J 20/3242

(57) ABSTRACT

This invention discloses an approach is improve the strength and reproducibility of the signal generated in FTAs using solid-phase microextraction (SPME) through the design of an approach to generate the plasmonically-enhanced signal for SERS, surface-enhanced infrared (SEIRA), and other enhanced spectroscopies. The design incorporates: (1) a particle-particle coupling strategy that is triggered by the selective capture of an analyte to a particle that has been immobilized on a membrane and has been modified to act as a capture substrate; (2) the selective tagging of the captured analyte by a nanoparticle also designed to generate an amplified plasmonic signal upon tagging; and (3) the incorporation of an internal nanoparticle standard to account for fluctuations in flow rates and flow paths. Collectively, these developments improve the accuracy and precision of the analysis as well as the SPME analysis accurately, improving the ease-of-use for a number of different SPME-based measurements, including, for example, those focused on disease markers using immunoassays and a range of other assay formats.

### REFERENCE TO RELATED APPLICATION

This application claims inventions disclosed in Provisional Patent Application No. 62/879,792, filed Jul. 29, 2019, entitled “SOLID PHASE MICROEXTRACTION MEMBRANES IMPREGNATED WITH GOLD NANOPARTICLES.” The benefit under 35 USC § 119(e) of the above-mentioned United States Provisional Applications is hereby claimed, and the aforementioned application is hereby incorporated herein by reference.

### FIELD OF THE INVENTION

This invention relates to organic, inorganic, and hybrid membranes used in solid-phase microextractions (SPMEs) that can be modified to act as plasmonically-enhanced materials by impregnation with gold, silver, and other types of nanoparticle/nanostructured materials in applying surface-enhanced Raman scattering (SERS), surface-enhanced infrared (SEIRA), and other enhanced spectroscopies with the use of internal standards in, for example, the analytical, bioanalytical, and combinatorial sciences.

### BACKGROUND

Membranes and related materials play important roles in a number of technological areas, including solid-phase microextractions (SPMEs), lateral and vertical flow chemical and biological tests, and sample pretreatment and concentration methodologies. Recent work has focused on the use of these materials in point-of-care (POC) diagnostic tests for the detection of markers for cancer and infectious diseases, environmental contaminants, and many other types of analytes (e.g., bacteria, viruses, proteins, DNA, small toxins, and heavy metals). The goal is to develop POC and other types of field-deployable tests that are accurate, rapid, easy to use, and low cost. These tests can be classified into two general categories: lateral flow assays (LFAs) and flow-through assays (FTA). LFAs rely on passage of the sample fluid across (laterally) a membrane designed for the selective concentration, labeling, and readout of an analyte. FTAs, the focus area for this invention, perform the same three tasks by directing the sample flow-through (vertically) the membrane. These flow-through formats enable the detection of analytes at levels rivaling, and, at times surpassing, those of the enzyme-linked immunosorbent assay (ELISA) and other types of diagnostic tests, but with easier-to-use operational procedures and shorter turn-around times.

While FTAs have proven invaluable in chemical and biological analyses, the strength of the readout signal can often be weak, which degrades the analytical sensitivity (i.e., the slope of a calibration or dose-response plot, which defines the ability to quantify small differences in the concentration of an analyte in different samples) and the limit of detection (LOD) (i.e., the lowest quantity of a substance that can be distinguished from a measurement of a sample blank at a stated confidence level). Fluctuations and irregularities in the rates and paths of the sample flow through the membrane can also negatively affect the accuracy and precision of the measurement. It is, therefore, evident that approaches which can address these limitations would improve the utility of FTAs.

### SUMMARY OF THE INVENTION

The goal of the present invention is to improve the strength and reproducibility of the signal measured in FTAs by means of an approach that generates the plasmonically-enhanced signal detected by SERS and other forms of the so-called plasmonically-enhanced spectroscopies. This design incorporates a particle-particle plasmonic coupling strategy that includes: (1) the selective capture of an analyte to a plasmonic particle (e.g., gold) that has been modified to act as a capture substrate for a target analyte and then immobilized on an SPME membrane or related architecture; (2) the selective tagging of the captured analyte by a plasmonic particle that has been designed to generate an amplified plasmonic signal when coupling with the plasmonic characteristics of the capture particle; and (3) the incorporation of an internal measurement standard to account for fluctuations in sample flow rates and flow paths. This integrative capability is demonstrated by using a sandwich immunoassay for a human immunoglobulin G protein (h-IgG).

### BRIEF DESCRIPTION OF THE FIGURES

The accompanying figures, when linked with the detailed descriptions that follow, serve to illustrate various embodiments of the invention, which aid in framing the operational principles and associated advantages of the invention.

FIG. 1 is an illustrative example of a flow-through assay (FTA) cartridge based on a solid-phase microextraction (SPME), consisting of an SPME membrane disk, a capture (reactive) address spotted on the disk, a liquid wicking pad to draw the sample through the membrane as a controlled flow rate, and the cartridge housing. The arrow depicts the direction of fluid flow;

FIG. 2A is an illustrative example of the preparation and architecture of a spherically-shaped gold nanoparticle (GNP) that can be prepared for use either for the selective capture of the target analyte and the internal standard. In this example, the capture particle consists of a spherical gold nanoparticle that is first coated with a layer of a linker molecule and then a layer comprised of two different antibodies, one to selectively capture the target analyte and the other antibody, which is necessarily different from that used to capture the analyte, to selectively capture the internal standard;

FIG. 2B is an illustrative example of the preparation and architecture of spherically-shaped gold nanoparticles (GNP) that can be prepared for use to selectively tag the captured analyte or the captured internal standard. In this example, the tag for the captured analyte is comprised of a spherical gold nanoparticle that is coated with a layer of a Raman reporter molecule (RRM) and then a layer of an antibody to selectively tag the captured target analyte. The tag for the captured internal standard is comprised an RRM and an antibody, both of which are necessarily different from their analogs used to tag the captured analyte, to selectively tag the captured internal standard;

FIG. 3 is an illustrative example of the architecture and workflow for an FTA using an SPME disk and the two types of GNPs as shown in FIG. 1 and FIG. 2. The first step immobilizes the dual-purpose capture GNPs in FIG. 2 to the SMPE membrane. This creates an SPME membrane that will selectively and concurrently extract and concentrate both the analyte and internal standard. The next step applies a small volume of the liquid sample, which has been previously spiked with an internal standard, to the flow-through capture membrane. The capillary action of the membrane and underlying wicking pad pulls the sample through the membrane. The analyte and internal standard in the sample are then selectively captured and concentrated by the membrane. The next step applies a small volume of a suspension containing a mixture of the GNP labels exemplified in FIG. 2B, for the selective tagging and SERS signaling for the captured of the target analyte and the internal standard;

FIG. 4A presents the SERS spectra collected for the analysis of samples spiked into PBS buffer (pH 7.4). The samples for analysis were prepared using different concentrations of h-IgG (−100 ng/mL), but with a fixed concentration of m-IgG (50 ng/mL). The resulting spectra are shown in FIG. 4A and correspond to: 0 ng/mL h-IgG (401), 1 ng/mL h-IgG (402), 10 ng/mL h-IgG (403), 25 ng/mL h-IgG (404), 50 ng/mL h-IgG (405), 100 ng/mL h-IgG (406);

FIG. 4B presents the Raman spectrum of the nitrocellulose SPME membrane for reference and comparative purposes;

FIG. 5A presents the calibration curve from the SERS measurement in FIG. 4A when only analyzing the strength of the νₛ(NO₂) for the DSNB-derived RRM that is coated on the GNPs used to tag the capture h-IgG analyte; and

FIG. 5B presents the calibration curve from the SERS measurement in FIG. 4A when only analyzing the response factor which if the strength of the SES signal measured for the captured h-IgG analyte (i.e., νₛ(NO₂) for the DSNB-derived RRM 1336 cm⁻¹) to that of the m-IgG internal standard (i.e., ν(CN) for the nitrile group of DMBN at 2225 cm⁻¹).

Skilled artisans will appreciate that some of the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

By way of context, the embodiments of the present invention are described within the framework of a heterogeneous immunoassay. It should, however, be readily recognized by practitioners skilled in the art that these embodiments apply well beyond this illustrative example to include the use of this invention across all areas of investigative and applied measurement science and technology.

Note that relational terms such as “first” and “second,” “top” and “bottom,” and the like may be used solely to distinguish one entity or action from another entity or action without necessarily requiring or implying any actual relationship or order between such entities or actions. The terms “comprises,” “comprising,” or any variations thereof, are intended to cover a non-exclusive inclusion such that a process, method, article, or apparatus that consists of a number of different and/or related elements is not limited to only those elements but may include other elements not expressly listed or inherent to such a process, method, article, or apparatus. An element proceeded by “comprises” does not, without more constraints, preclude the existence of a number of additional identical elements in the process, method, article, or apparatus that comprises the element.

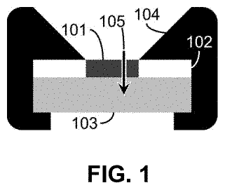

FIG. 1 through FIG. 3 provide context for the disclosed invention, FIG. 1 serves as an illustrative example of a typical, easily multiplexed, design of the cartridges used in today's flow-through assays (FTAs). The cross-section perspective of a typical easily multiplexed design of a cartridge used in today's flow-through assays (FTAs). The cutaway view shows the four main components of a cartridge: a capture (reactive) address spotted on an SPME disk (101), the membrane disk itself (102), a wicking pad (103), and the membrane housing (104); the arrow depicts the direction of fluid flow (105). Note that SPME membranes can be fabricated from any number of materials typically used as reaction vessels for chemical and biochemical reactions and analyses, including but are not limited to: natural and human-made biomaterials, wood, paper, textiles (natural/synthetic), leather, glass, crystalline materials, biocomposite materials (bone/conch shell), plastics (natural/synthetic), rubber, (natural/synthetic), carbon, graphite, graphene, carbon nanotubes, and diamond materials, wax (natural/synthetic), metals, minerals, stone, concrete, plaster, ceramics, foams, salts, metal-organic frameworks (MOFs), covalent organic frameworks (COFs), nanomaterials, metamaterials, semiconductors, insulators, and composites of all of these. The cartridge structure in FIG. 1 can also be easily modified for operation with a low volume flow actuator like, for example, a syringe pump.

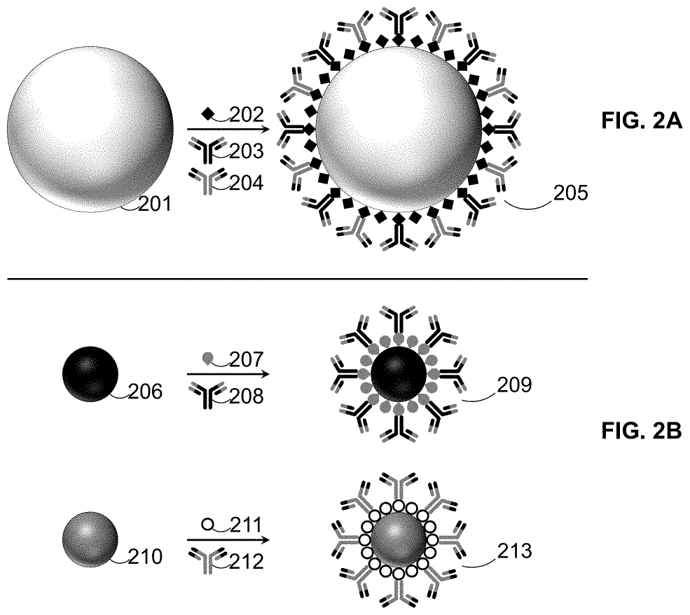

FIG. 2 exemplifies architectures for the two different types of plasmonic materials used in a sandwich immunoassay or comparable type of analytical measurement when read out by surface-enhanced Raman spectroscopy. FIG. 2A shows an example of the preparation process and architecture for a spherically-shaped gold nanoparticle (GNP) that can be used to selectively and concurrently capture the target analyte and the internal standard from the liquid sample. In this example, the capture particle (205) is comprised of a spherical gold nanoparticle (201) that is coated with a layer of a linker molecule (202), which is further modified with a coating comprised of an antibody to selectively capture the target analyte (203) and an antibody to selectively capture the internal standard (204). Note that the antibody to capture the target analyte differs from the antibody to capture the internal standard.

FIG. 2B shows examples of the preparation and structure of spherically-shaped gold nanoparticles (GNP) that can be prepared to selectively tag the captured analyte (209) or to selectively tag the captured internal standard (213). In this example, the nanoparticle tag for the captured analyte (209) is comprised of a spherical gold nanoparticle (206) that is coated with a layer of a Raman reporter molecule (RRM) (207) and then a layer of an antibody (208) to selectively tag the captured target analyte. The nanoparticle tag for the captured internal standard (213) is comprised of an RRM (211) and an antibody (212) that selectively tags the captured internal standard. Note that: (1) the antibody to tag the captured analyte differs from the antibody to tag the captured internal standard, and (2) the RRM used to indirectly label the captured analyte differs from the RRM used to label the captured internal standard. Operationally, the presence of the target analyte and the internal standard in the sample is signaled by the characteristic Raman spectrum for each of the two different RRMs, and that the amounts of both can be quantified by the strength of the response of the strongest spectral feature of each RRM by comparison to a calibration plot prepared any of the approaches to analyzing data involving an internal standard, and by assuming a 1:1 reaction stoichiometry between the captured analyte and it specific GNP label and for the captured internal standard and its specific GNP label. While this example uses spherically shaped gold nanoparticles, there are a number of other types of plasmonic materials, i.e., those are consisting of silver, or other plasmonically-active inorganic, organic, core-shell, or other hybrid material—to form the sandwich complex that can be detected by SERS and other enhanced spectroscopies. These plasmonic materials can also be used in a wide range of sizes (e.g., 5-250 nm) and shapes (e.g., cubes, prisms, plates, rods, wires, and stars). Note that the strength of the turn-on, amplified optical signal is controlled, in part, by the gap between the two plasmonic particles, which is directly related to the size of the “biorecognition complex” that is formed by the capture and tagging of the analyte by the two different types of modified GNPs.

By way of context, the method of internal standards is used as a means to improve the precision and accuracy of quantitative measurements. An internal standard is chosen to match as many of the chemical and physical characteristics of the target analyte as possible but have a measurable signal that can be easily distinguished from that of the analyte. Ideally, any factor that affects the analyte signal, including fluctuations in the flow rate or flow path of a sample through an SPME membrane, will affect the signal of the internal standard to the same degree. Therefore, the ratio of the signal for the analyte to that of the internal standard, which is added at the same concentration for all of the samples analyzed, undergoes a lower level of variability than that of the analyte alone. An analyte is often quantified by using an internal standard by using a calibration curve, the method of standard addition, or the so-called “response factor” or RF, which is defined as the ratio of sensitivities of the analyte signal to that of the internal standard.

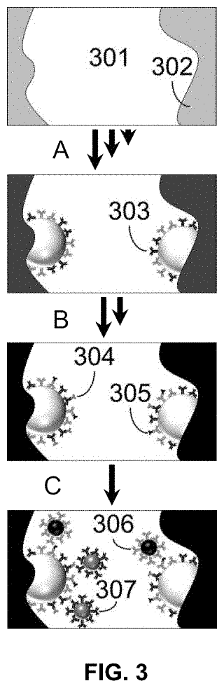

FIG. 3 expands on the description of an FTA by detailing the steps involved in a heterogeneous immunoassay carried out using the cartridge illustrated in FIG. 1. More specifically, FIG. 3 exemplifies the architecture and workflow for an FTA using SPME and two sets of GNPs shown in FIG. 2, which serve as the capture (FIG. 2A) and labeling (FIG. 2B) plasmonic materials for assay readout by surface-enhanced Raman spectroscopy (SERS). The construction of the FTA begins in step A by filling the pores (301) in a SPME membrane (302) with a suspension of the capture GNPs (303) exemplified in FIG. 2A. Depending on the SPME material, the capture GNPs (303) can be fixed to the SMPE membrane in a number of ways. Examples for nitrocellulose materials include using poly(glycidyl methacrylate) coatings to react the amine groups located at the outer periphery of the immobilized antibodies, thereby anchoring the GNPs to the SPME membrane. Another pathway focuses on the creation of carboxylic acids by reaction with hydrogen peroxide or chromic acid, which, after activating by forming succinimidyl esters groups, react with amine groups to form amide linkages.

After the immobilization of the capture GNPs, a small volume of sample (step B) is deposited on the membrane, which is then pulled through the membrane by the capillary draw of the membrane and wicking pad. As the sample slowly flows through the membrane, the analyte (304) and internal standard (305) in the sample are selectively captured and concentrated on the surface of the capture GNPs by their specific antibodies. The next step (step C) applies a small volume of a suspension of a mixture of the two different labeling GNPs (see FIG. 2B), which selectively and concurrently tag the captured analyte (306) and the captured internal standard (307). As noted earlier, this set of labels selectively tags the captured target analyte and captured internal standard with RRMs that have a distinctly different set of spectral features that can be used for identification and for analyte quantification.

The presence of the analyte is indirectly identified by the characteristic SERS spectrum of a GNP-bound RRM and is quantified by the strength of its most intense spectral feature. The presence of the internal standard is also indirectly identified by the characteristic SERS spectrum of a GNP-bound RRM and quantified by the strength of its most intense spectral feature.

By away of added context, these types of detection platforms are becoming increasingly important to clinical screening and diagnostic devices. One of the most common types of micro assays is surface capture assays, which employ antibodies, oligonucleotides, carbohydrates and other forms of molecular recognition elements (MREs) that are immobilized onto a surface in order to bind a target disease marker or other type of analyte selectively. Interestingly, these materials also stand as analytes that can also be detected by this technology. Other analytes, like bacteria, toxins, environmental contaminants, and heavy metals, are also measurable by this technology.

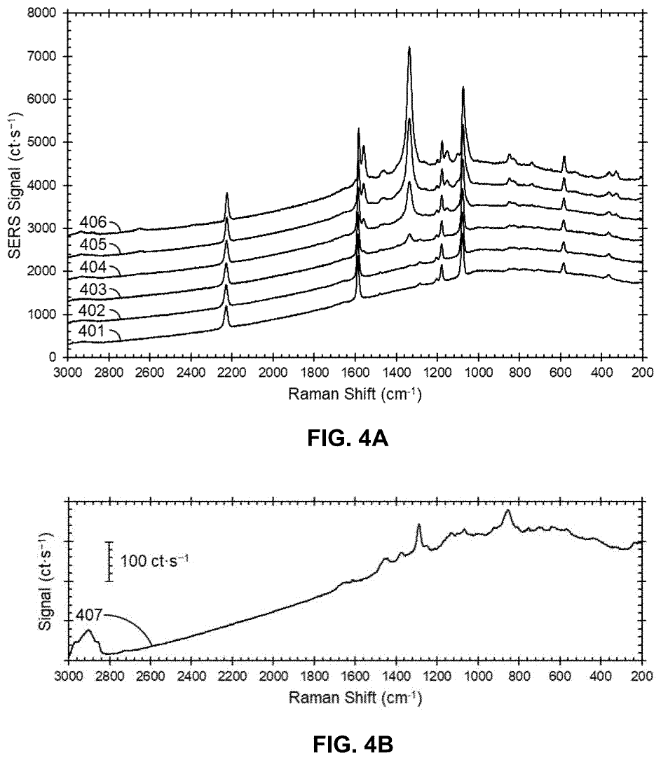

While this invention can be readily adapted for any of the and other measurements, the results from an assay for h-IgG using this particle-particle plasmonic coupling methodology for SERS signal generation, which are given in FIG. 4, serve to demonstrate this overall capability. This set of experiments used phosphate-buffered saline (PBS; 20 mM, pH 7.4) that has been spiked with different amounts (0-100 ng/mL) of human IgG (h-IgG), which will serve as the target analyte, and with a fixed amount (50 ng/mL) of mouse IgG (m-IgG), which will act as the internal standard. To capture the analyte and internal standard, the SPME membrane was modified a suspension of capture particles comprised of spherical GNPs (˜60 nm diameter) that were coated with equal amounts of an antibody for h-IgG (α-h-IgG) and an antibody for m-IgG (α-m-IgG) in accordance with FIG. 2A.

Similarly, particles used to selectively tag the captured analyte and captured internal standards were prepared using GNPs with a diameter of ˜20 nm. The labeling GNPs for the analyte, h-IgG, was coated first with a layer of the RRM 5,5′-dithiobis-(succinimidyl-2-nitrobenzoate) (DSNB) and then a layer of α-human IgG. The symmetric stretching mode of the nitro group [νₛ(NO₂)] of DSNB, which is at 1336 cm⁻¹, was used to identify the presence and measure the amount of the captured target analyte. The labeling GNPs for the internal standard, m-IgG, was coated first with a layer of the RRM 4,4′-dithiobis-benzonitrile (DMNB) and then a layer of α-mouse IgG. The stretching mode, ν(CN), for the nitrile group of DMBN, which is at 2225 cm⁻¹, was used to identify the presence and measure the amount of the captured internal standard.

The samples for analysis were prepared using different concentrations of h-IgG (0-100 ng/mL), but with a fixed concentration of m-IgG (50 ng/mL). The resulting spectra are shown in FIG. 4A and correspond to: 0 ng/mL h-IgG, 1 ng/mL h-IgG, 10 ng/mL h-IgG, 25 ng/mL h-IgG, 50 ng/mL h-IgG, 100 ng/mL h-IgG. The SERS spectra collected for measurements on the different samples after completion of all assay procedures are composed of spectral features that can be readily assigned to the vibrational modes of the two different RRMs, which confirms that the immobilized capture nanoparticles are effective in binding the analyte, h-IgG, and the internal standard, m-IgG, and that the two different labeling nanoparticles are also functioning as expected. More importantly, the strength of the νₛ(NO₂) for the DSNB-derived RRM that is coated on the GNPs (20 nm diameter) designed to selectively tag captured h-IgG increases as the solution concentration h-IgG increase, which is consistent with expectations of a sandwich immunoassay. Note that the spectral features for nitrocellulose in FIG. 4B are virtually undetectable in view of the strength of the SERS responses in FIG. 4A, which is an indicator of the strength of the signal enhancement due to the plasmonic signal amplification induced by nanoparticle-nanoparticle coupling.

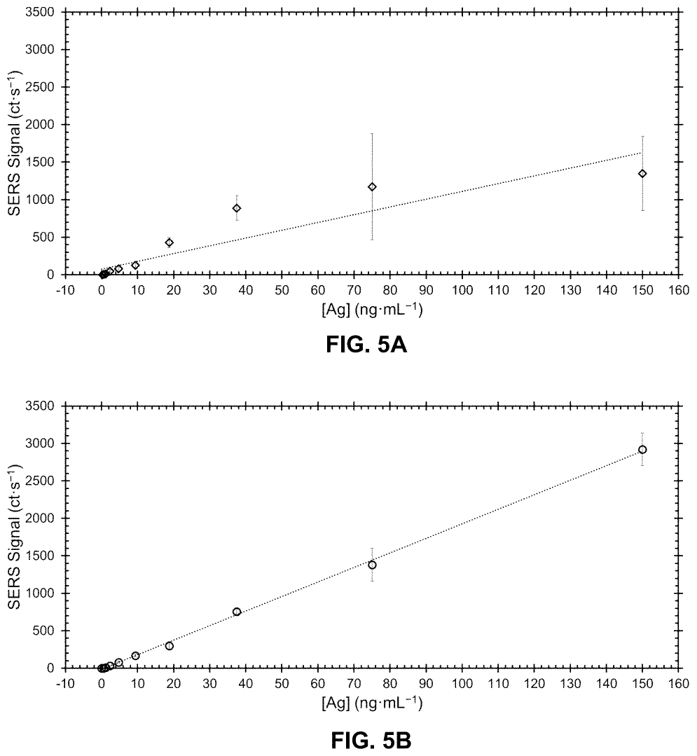

FIG. 5 presents examples of the calibration plots for this measurements without (FIG. 5A) and with (FIG. 5B) incorporating the signal from the internal standard to aid in accounting for variabilities and irregularities in each of the preparation steps for each of the components in the immunoassay and in the capture and labeling processes. FIG. 5A shows the measured SERS intensities for the νₛ(NO₂) at 1336 cm⁻¹ for the DSNB-based RRM on the GNPs that tag only the captured analyte. As expected for a sandwich immunoassay, the signal increases as the concentration of the h-IgG analyte increases. The linear least squares best fit plot to the data has a slope and y-intercept of 8.5 ct·mL·s⁻¹·ng⁻¹ and 10.4 ct·s⁻¹, respectively. From this plot, the LOD for measuring h-IgG is 11 ng mL⁻¹. The correlation coefficient, i.e., the R² value, for the best fit line is 0.714.

The calibration plot after accounting for the response of the m-IgG internal standard is shown in FIG. 5B. In this case, the y-axis is given as the ratio of the signal for the νₛ(NO₂) of the GNPs that tagged the captured analyte to that of the ν(CN) for the DMBN-based RRM on the GNPs that tag the captured internal standard. This plot, like that in FIG. 5A, exhibits a linear increase in magnitude with the increase in the concentration of the h-IgG analyte. More importantly, the performance metrics for the measurement are markedly improved. The slope of this plot is 19.4±0.299 ct·mL·s⁻¹·ng⁻¹, and the y-intercept is −4.1 ct·s⁻¹, which translates to a LOD for h-IgG of 0.2 ng·mL⁻¹. The correlation coefficient, i.e., the R² value, for the best fit line is 0.991.

The impact of the incorporation of an internal standard, which results, for example, in an improvement in the LOD by more than 50×, can also be examined by considering the definition of the correlation coefficient. The correlation coefficient, which is also called the coefficient of determination or R², is a measure of how closely the actual experimental data is represented by the linear least squares fit to the data. Values for R² range from 0 to 1.0. Comparatively, a lower value for R² typically indicates that the linear least squares fit to the data is a poor representation of the trend within the data set, whereas a higher value of R² is often viewed to indicate that linear least squares fit to the data is a more accurate representation of the trend within the data set. The difference in the R² value found when incorporating the response from the internal standard into the data analysis (0.991) with respect to the R² value (0.714) calculated using only the raw data clearly underscore the importance of incorporating an internal standard into the measurement protocol.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims, including any amendments made during the pendency of this application and all equivalents of those claims as issued.

What is claimed is:

1. A method for measuring the concentration of an analyte in a liquid sample, the method comprising the steps of:
adding an internal standard to the liquid sample at a predetermined concentration;
providing a solid-phase microextraction (SPME) device, the SPME device comprising plasmonic particles immobilized on a capture substrate, a first type of molecular recognition element (MRE) coated on the plasmonic particles for capturing the analyte, and a second type of molecular recognition element (MRE) coated on the plasmonic particles for capturing the internal standard;
capturing the analyte and the internal standard with the SPME device;
measuring signals of the captured analyte and the captured internal standard; and
comparing the signal of the captured analyte to the signal of the captured internal standard to predict the concentration of the analyte.

2. The method of claim 1, wherein the plasmonic particles are coated with reporter elements.

3. The method of claim 1, wherein the plasmonic particles enhance the signals of the captured analyte and the captured internal standard.

4. The method of claim 1, wherein the plasmonic particles comprise gold, silver, or other plasmonically active inorganic, organic or hybrid material particles.

5. The method of claim 1, wherein the plasmonic particles take the shapes of spheres, cubes, prisms, plates, rods, wires, stars, or their combinations.

6. The method of claim 1, wherein the size of the plasmonic particles range from 5 to 250 nm.

7. The method of claim 1, wherein signals of the captured analyte and the captured internal standard are measured with an enhanced spectroscopy technique.

8. The method of claim 7, wherein the enhanced spectroscopy technique includes but is not limited to surface-enhanced Raman spectroscopy (SERS), surface-enhanced resonance Raman spectroscopy (SERRS) surface-enhanced infrared spectroscopy (SEIRA), and surface enhanced fluorescence spectroscopy (SEF).

9. The method of claim 1, wherein the molecular recognition element (MRE) comprises antibodies, antigens, oligonucleotides, carbohydrates, aptamers, and other types of selective complexation reagents.

10. The method of claim 1, wherein the first and second type of molecular recognition element (MRE) are coated on the same plasmonic particles.

11. The method of claim 1, wherein the first and second type of molecular recognition element (MRE) are coated on different plasmonic particles.

12. The method of claim 1, wherein the internal standard has chemical and physical characteristics matching closely with that of the analyte.

13. A solid-phase microextraction (SPME) device for measuring the concentration of an analyte in a liquid sample, the SPME device comprising:
plasmonic particles immobilized on a capture substrate;
a first type of molecular recognition element (MRE) coated on the plasmonic particles for capturing the analyte in the liquid sample; and
a second type of molecular recognition element (MRE) coated on the plasmonic particles for capturing an internal standard added to the liquid sample at a predetermined concentration;
wherein a signal of the captured analyte is compared to a signal of the captured internal standard to predict the concentration of the analyte.

14. The (SPME) device of claim 13, wherein the plasmonic particles are coated with reporter elements.

15. The (SPME) device of claim 13, wherein the plasmonic particles enhance the signals of the captured analyte and the captured internal standard.

16. The (SPME) device of claim 13, wherein the plasmonic particles comprise gold, silver, or other plasmonically active inorganic, organic or hybrid material particles.

17. The (SPME) device of claim 13, wherein the plasmonic particles take the shapes of spheres, cubes, prisms, plates, rods, wires, stars, or their combinations.

18. The (SPME) device of claim 13, wherein the size of the plasmonic particles range from 5 to 250 nm.

19. The (SPME) device of claim 13, wherein signals of the captured analyte and the captured internal standard are measured with an enhanced spectroscopy technique.

20. The (SPME) device of claim 19, wherein the enhanced spectroscopy technique includes but is not limited to surface-enhanced Raman spectroscopy (SERS), surface enhanced resonance Raman spectroscopy (SERRS) surface-enhanced infrared spectroscopy (SEIRA), and surface enhanced fluorescence spectroscopy (SEF).

21. The (SPME) device of claim 13, wherein the molecular recognition element (MRE) comprises antibodies, antigens, oligonucleotides, carbohydrates, aptamers, and other types of selective complexation reagents.

22. The (SPME) device of claim 13, wherein the first and second type of molecular recognition element (MRE) are coated on the same plasmonic particles.

23. The (SPME) device of claim 13, wherein the first and second type of molecular recognition element (MRE) are coated on different plasmonic particles.

24. The (SPME) device of claim 13, wherein the internal standard has chemical and physical characteristics matching closely with that of the analyte.
